(19) United States
(12) Patent Application Publication
(10) Pub. No.: US 2015/0257414 A1
(43) Pub. Date: Sep. 17, 2015

(54) MINERAL BLOCK WITH INTEGRATED AEROMATIC ATTRACTANT AND METHOD FOR PRODUCTION OF THE SAME

(71) Applicant: Mark Bowles, Waco, TX (US)

(72) Inventor: Mark Bowles, Waco, TX (US)

(21) Appl. No.: 14/675,028

(22) Filed: Mar. 31, 2015

Related U.S. Application Data
(63) Continuation-in-part of application No. 13/986,046, filed on Mar. 27, 2013.

(51) Int. Cl. A23K 1/175; A23K 1/00

(52) U.S. Cl. CPC A23K 1/1753; A23K 1/003; A23K 1/1751

(57) ABSTRACT

The present disclosure relates to a system for attracting animals, a method of producing the system, and a system for attracting animals produced by a specific process. The animal attracting system includes a mineral attractant portion and an integrated aromatic attractant portion. The method of producing the system allows for production of a hardened mineral block without the need for application of heat or pressure during the curing of the mineral block.

### CROSS-REFERENCE TO RELATED APPLICATIONS

This applications claims priority to U.S. patent application Ser. No. 13/986,046, filed Mar. 27, 2013, which is hereby incorporated by reference in its entirety.

### FIELD OF THE INVENTION

The present disclosure relates to apparatuses, systems and methods for attracting animals. More specifically, this disclosure relates to mineral blocks incorporating an integrated aromatic attractant, and the method and process of their manufacture.

### BACKGROUND OF THE INVENTION

There are many reasons that an individual may wish to attract an animal, or animals, to a specific location. Hunters often employ one or more of a multitude of means for attracting their desired game animals in order to have the greatest possible opportunity of being successful in their hunt. Similarly, naturalists and wildlife photographers may utilize animal attractants to increase the probability of viewing a specific type of animal.

### BRIEF SUMMARY OF THE INVENTION

Individuals seeking to attract a type of animal to a specific location may employ the use of attractants that are specifically designed to attract that particular type of animal.

Attractants that are commonly used include, but are not limited to: natural scents, artificial scents, food bait, mineral blocks, animal calls, and decoy animals.

Deer, as well as other animals, may be attracted by scent, food, and mineral attractants. Hunters use scents and decoys to draw bucks into range for a successful kill-shot. This can be especially effective during the “rut”. Hunters may use doe in esterous scent to pique a buck's interest and decoys to fix the visual interest of the buck away from the hunter, who is often concealed in a blind or tree stand.

Mineral licks are also used to attract animals to a location. A mineral lick (also known as salt lick) is a mineral deposit where animals can obtain essential mineral nutrients. In an ecosystem, mineral licks often occur naturally, providing the sodium, calcium, iron, phosphorus, and zinc required in the springtime for bone, muscle and other growth in deer and other wildlife, such as moose, elephants, tapirs, cattle, woodchucks, sheep, foxes, squirrels, mountain goats, and porcupines.

Additionally, the minerals contained in mineral blocks can be beneficial for the overall health of the animal consuming the mineral block, as well as for the development of their antlers or horns.

Hardened antlers contain 40 to 50 percent organic matter, mostly from proteins, while the most abundant minerals therein consist of calcium and phosphorus. The demands for these minerals on a daily basis can be significant for antler production.

Furthermore, a lactating doe's milk contains high percentages of both calcium and phosphorus, which can also result in a significant mineral drain on the animal. Phosphorous cannot be synthesized by the body so it must be provided in required levels through the animal's diet. Thus, the minerals found in mineral licks may prove very valuable, and thereby attractive, to an animal if the animal's habitat is lacking in these materials.

People use mineral licks to attract or maintain wildlife, whether it is for viewing, photography, farming, or hunting purposes.

A mineral block may include a scent attractant component integrated into exterior and/or interior portions of the mineral block. In embodiments, a scent component may remain effective as the mineral block degrades, such as due to animal feeding, or environmental exposure (rain, etc.). In embodiments, exterior and interior portions may include a scent component that is effective continuously when new and as the exterior portion deteriorates such that the scent component of the mineral block degrades at a rate whereby efficacy of the attractant qualities of the system maintains constant or increase.

In embodiments, a mineral block may include a scented attractant incorporated therein, which do not rely on a “vapor trail” being released, and furthermore, that do not rely on a vapor trail being induced by exposure to rainfall.

Mineral blocks lacking scent components may be produced through the application of pressure and heat to a mixture of salt and other minerals that have been mixed with a mixing agent such as water or mineral oil. The heat and pressure applied to the mixture force out excess mixing agent from the mixture, thereby causing the remaining minerals to conform to a mold in which the mixture is contained. This process requires machinery to apply pressure to the mixture, and sometimes requires heating of the mixture under pressure in order to achieve a hardened mineral block which will be resistant to physical degradation.

Throughout the present disclosure reference will be made to deer. While embodiments of the system described herein may be suitable for use in the attracting of deer specifically, it is intended that the systems and methods taught in the present disclosure include embodiments applicable for use in attracting animals other than deer. The embodiments referenced throughout this disclosure are intended to be exemplary in nature, and are not intended to limit the scope of this disclosure in any way.

Embodiments disclosed herein delineate a system and apparatus for attracting animals comprising a mineral block having an integrated scent cell, and the method and process by which the system is made. It will be understood that apparatus as herein disclosed may be embodied in an article of manufacture as described.

In an embodiment a system may comprise a hardened mineral block having a recessed portion for containing a scent component or scent cell. The mineral block may be an article of manufacture comprising a combination of minerals, including but not limited to, sodium chloride, mineral salt, calcium sulphate, calcium, and trace minerals. In embodiments, a scent component or scent cell may comprise an aromatic attractant. In embodiments, a scent component or scent cell may comprise a wax comprising an aromatic attractant.

In embodiments, the scent component or scent cell may comprise an enduring support medium. The enduring support medium may support the aromatic attractant in such a manner as to enable the aromatic attractant to remain effective despite degradation of the support medium itself, or despite degradation of the other constituent elements of the system.

In an embodiment, a mineral block may be formed by mixing a powdered form of the constituent minerals together. A volume of water approximately equal to one tenth of the mass of the mineral mixture is then added to the powdered mineral mixture. The mineral mixture and water are then mixed thoroughly in order to create a slurry. The slurry is then poured into a mold. The slurry is then allowed to dry in the mold at ambient conditions. No heat or pressure is needed in order to cure the mineral block. Once the slurry dries the mineral block may be removed from the mold.

In an embodiment, the scent cell may be added to the molded mineral block. The scent cell may be produced by melting wax and infusing the melted wax with an aromatic attractant to provide a scent infused wax. In an embodiment, while in fluid form, the infused wax is poured into a recessed portion molded into the mineral block. The infused wax is then allowed to cool and solidify, thereby forming an integrated scent cell.

Embodiments may include a releasing agent configured to prevent the slurry and/or mineral block from adhering to the mold itself.

In an embodiment, exposure of the aromatic attractant to ambient conditions may be limited by having only a relatively small portion of the scent cell exposed to the air through either part of the recessed portion of the mineral block, an aperture, or a combination thereof. In embodiments, a system is capable of providing sufficient exposure of the scent cell to air to facilitate attracting animals for a prolonged period of use. In embodiments, rapid degradation of the scent cell may be prevented by limiting the amount of the scent cell's surface area that is exposed to the ambient environment. In embodiments, efficacy of the aromatic attractant portion of the system may be prolonged.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, which for part thereof:

FIG. 1 depicts a top view of an exemplary embodiment of a system including a mineral block having a recessed portion for retaining a scent cell.

FIG. 2 depicts a perspective view of an exemplary embodiment of a system including a mineral block with an integrated scent cell.

FIG. 3 depicts a flow chart showing an exemplary method of producing a mineral block.

FIG. 4 depicts a flow chart showing an exemplary method of producing a scent cell.

FIG. 5 depicts a flow chart showing an exemplary method of producing a system including a mineral block with an integrated scent cell.

### DETAILED DESCRIPTION OF ILLUSTRATIVE EMBODIMENTS

Reference now should be made to the associated FIGURES, in which the same reference numbers are used throughout the different FIGURES to designate the same components.

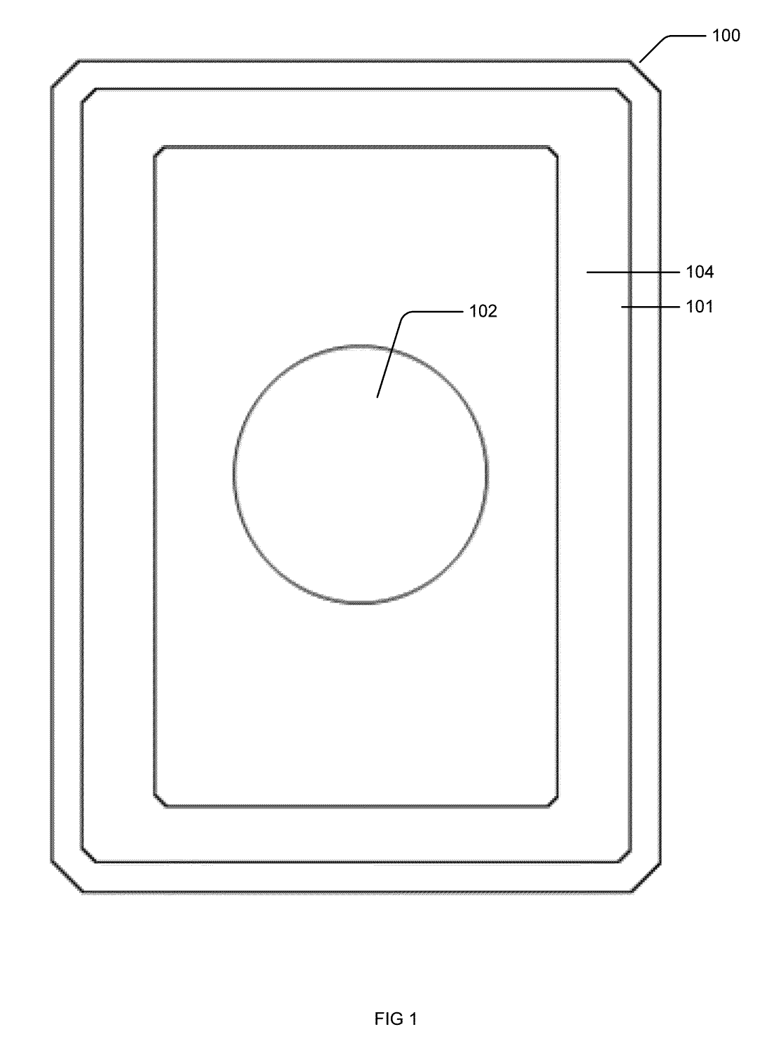

With reference to FIG. 1, embodiments of the teachings herein may include a system 100 for attracting animals, the system 100 comprising a mineral block 101 comprising a body portion 104 and a recessed portion 102, wherein the recessed portion 102 comprises an open volume recessed into a side of the body portion 104. In embodiments, an open volume for the scent cell may be essentially a hole drilled, cast, or molded into the mineral block, and wherein the body portion 104 comprises a plurality of minerals.

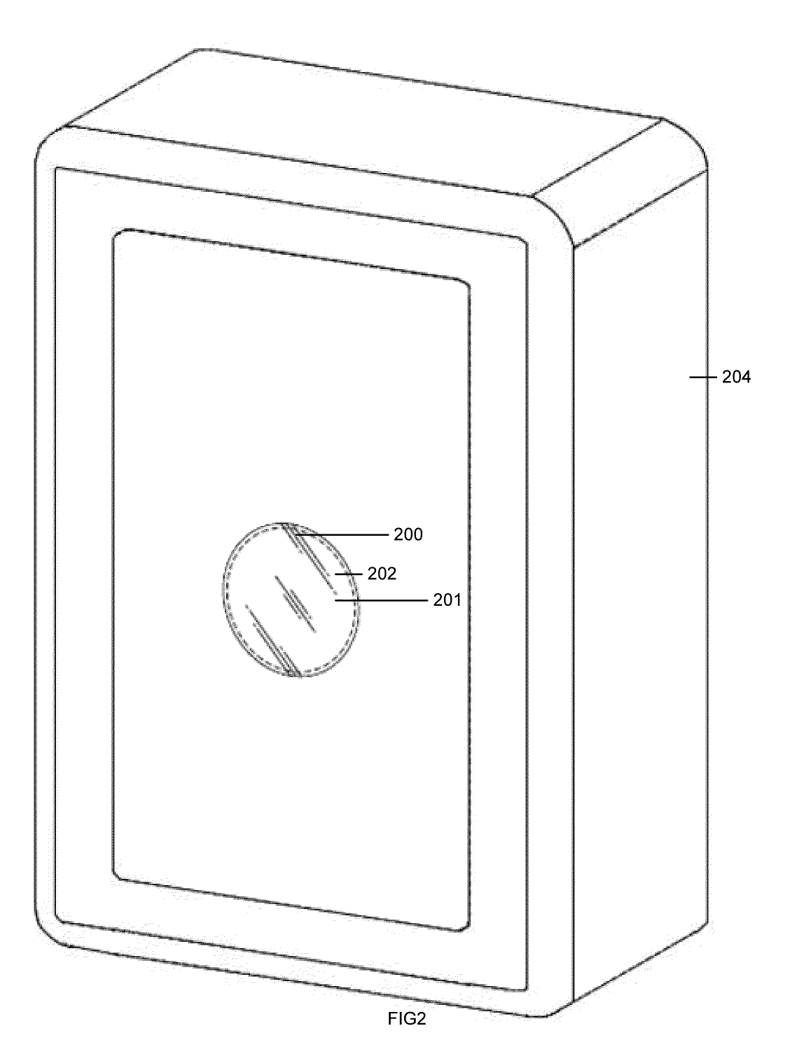

With reference to FIG. 2, embodiments of system 100 may further comprise a scent cell 200 comprising a wax 201 infused with an aromatic attractant 202, wherein the scent cell 200 is positioned substantially within the recessed portion 102 of the mineral block 101. It will be understood that in embodiments, a scent cell 200 May be secured within recessed portion 102 of body portion 104, such as by adhesion or interference fit.

Embodiments of the mineral block 101 may comprise a plurality of minerals. In embodiments, the plurality of minerals may include, but is not limited to, sodium chloride, mineral salt, calcium sulphate, iron oxide, manganous oxide, zinc oxide, ferrous carbonate, copper oxide, calcium iodate, cobalt carbonate, calcium carbonate, sodium selenite, and trace minerals.

Trace minerals may include, but are not limited to, calcium, phosphorus, magnesium, sodium, selenium, copper, cobalt, manganese, iron, iodine, and zinc.

Embodiments may include a mineral block being primarily made of a mineral mixture comprising substantially 55 percent (by mass) mineral salts and substantially 45 percent (by mass) calcium sulphate. One of ordinary skill will understand that, in embodiments different ratios of the constituent materials may be used. In embodiments, different ratios may provide different benefits and results for attracting animals in various conditions. In embodiments, a mineral block 101 may comprise from 40 to 60 percent by mass salt and from 60 to 40 percent by mass calcium sulphate. It will be understood that tin embodiments, a ration of mineral salts to calcium sulphate may be sufficient for a mineral block formed therefrom to possess structural integrity in ordinary use as an attractant. The relative percentages of the constituent materials included in the mineral block dictate the degree to which the block solidifies. The calcium sulphate operates as a binding agent that allows the slurry to solidify into a hardened mineral block. The less calcium sulphate included in the mixture the more easily the mineral block will crumble. Reciprocally, higher percentages of calcium sulphate present in the mixture will cause the resulting mineral block to be harder and less likely to crumble.

Embodiments of a scent cell may comprise one or more aromatic attractants that are natural and/or synthetic. Suitable aromatic attractants may include any aromatic compounds that may assist in attracting animals. Embodiments may include, for example, aromatic attractants that smell like apples, acorns, molasses, peanut butter, and berries.

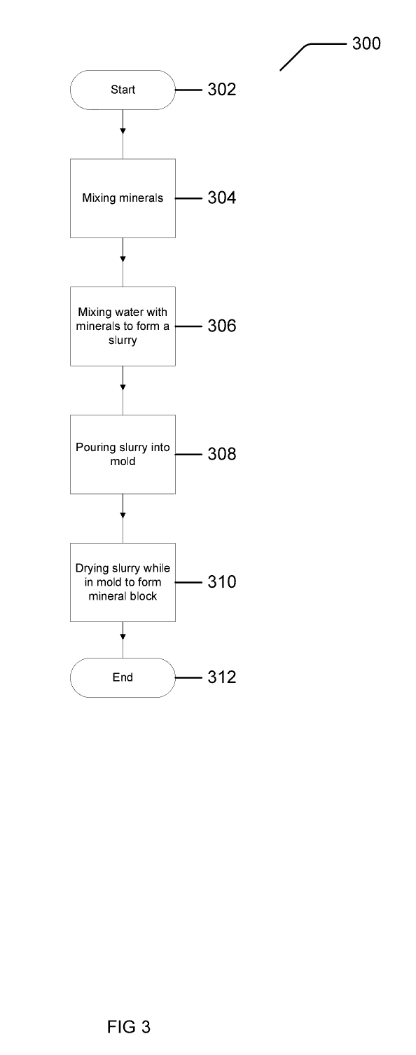

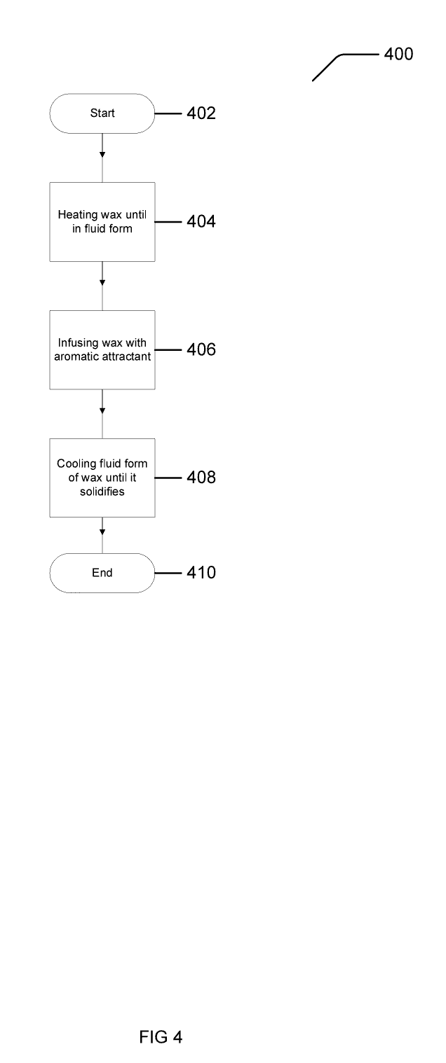

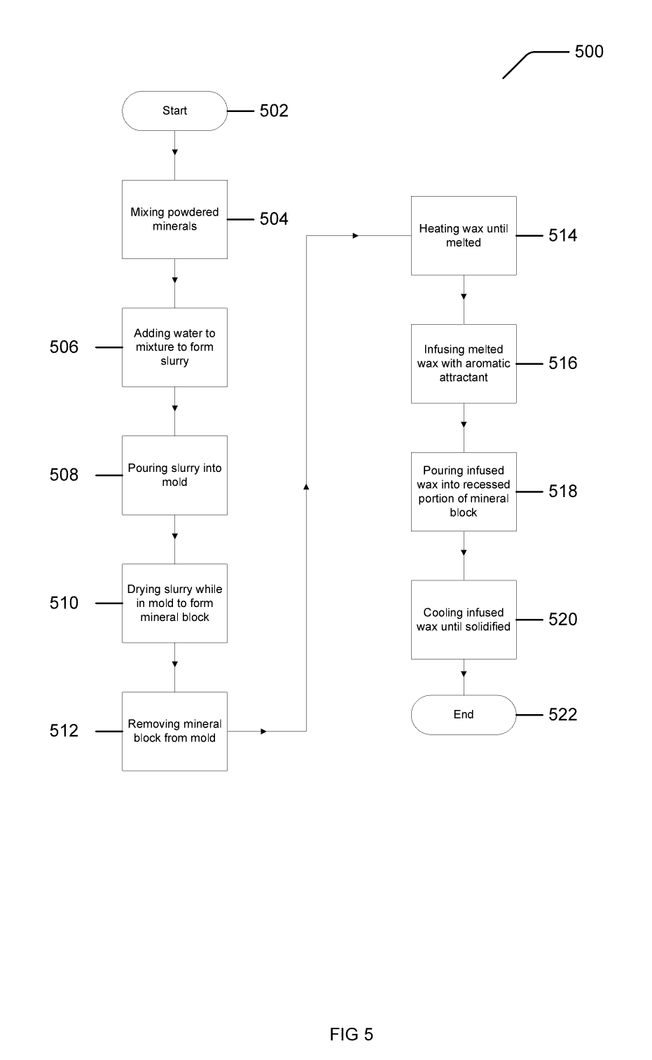

With reference to FIG. 3, the system of the mineral block with a recessed portion for retaining a scent cell may be produced through method 300. Method 300 may comprise mixing 304 a plurality of substantially powdered minerals, the plurality of minerals comprising at least sodium chloride and calcium sulphate. Method 300 may comprise mixing 306 a volume of water with the plurality of minerals to form a slurry. In an embodiment, for example, such a volume of water may be approximately equal to one tenth of the mass of the mineral mixture. Method 300 may comprise pouring 308 the slurry into a mold defining the body portion of a mineral block. In an embodiment method 300 may comprise forming 309 a recessed portion within the body portion of the mineral block, the recessed portion having a recess volume for containing a scent cell. In an embodiment, method 300 may comprise forming 309 a recessed portion by molding the body portion in a mold configured to provide a shape having a recessed portion. In an embodiment, a recessed portion may be drilled into the mineral block after casting the mineral block body portion in a mold. Method 300 may comprise drying 310 the slurry in the mold. In an embodiment, drying 310 may comprise dried slurry being allowed to dry to form a hardened body portion of a mineral block. In an embodiment, the drying process taught herein may not require the application of either heat or pressure to the system. In an embodiment, drying occurs at ambient conditions. In an embodiment, only evaporation is required in order to convert the slurry into the body portion of a mineral block. In an embodiment, method 300 comprises removing 312 the dried mineral block from the mold. Removal of the mineral block from the mold may be facilitated through the use of an agent designed to prevent the slurry, or the dried mineral block, from adhering to the mold. Method 300 may include infusing 406 an enduring support medium with an aromatic attractant. It will be understood that infusing 406 may be accomplished in any suitable manner such as, for example, as disclosed in FIGS. 4 and 5 and paragraph [0037] hereinbelow.

Method 300 may include introducing 518 an enduring support medium having an aromatic attractant into the recessed portion formed in the body portion of the mineral block.

In reference to FIGS. 4 and 5, in an embodiment, a method 400 for providing a scent cell may comprise infusing 406 an enduring support medium with an aromatic attractant. In an embodiment, method 400 may further comprise heating 404 a wax until the wax is in a fluid form before infusing 406 the fluid wax with an aromatic attractant. Methods of infusing 406 a wax with a scent may be performed in several ways and will be known to one skilled in the art. Once the wax has been infused with the aromatic attractant the infused wax may be poured into the recessed portion of the mineral block 518. The infused wax may then be allowed to cool 408, while in the recessed portion of the mineral block until the infused wax solidifies 520, thereby forming the integrated scent cell.

What is claimed is:

1. A system for attracting animals, the system comprising:
a mineral block comprising a body portion and a recessed portion, wherein the recessed portion comprises an open volume recessed into a side of the body portion, and wherein the body portion comprises a plurality of minerals; and
a scent cell comprising a wax, the wax comprising an aromatic attractant, wherein the scent cell is positioned within the recessed portion of the mineral block.

2. The system of claim 1, wherein the plurality of minerals include at least one of the minerals selected from the group consisting of:
sodium chloride;
mineral salt;
calcium sulphate;
calcium carbonate;
iron oxide;
zinc oxide;
ferrous carbonate;
copper oxide;
calcium iodate;
cobalt carbonate;
sodium selenite; and
trace minerals.

3. The system of claim 1, wherein the body portion comprises salt and calcium sulphate.

4. The system of claim 3, wherein the body portion comprises 55 percent by mass salt and 45 percent by mass calcium sulphate.

5. The system of claim 3, wherein the body portion comprises between 40 and 60 percent by mass salt and between 60 and 40 percent by mass calcium sulphate.

6. The system of claim 1, further comprising an aperture in a surface of the body portion, wherein the aperture provides for access to the recessed portion from a side of the body portion other than the side of the body having the recessed portion.

7. The system of claim 1, wherein the aromatic attractant comprises at least one natural scent.

8. The system of claim 1, wherein the aromatic attractant comprises at least one artificial scent.

9. The system of claim 1, wherein the scent cell is enclosed by the mineral block on all but a single side.

10. The system of claim 1, wherein the system consists of bio-degradable material.

11. The system of claim 1, wherein the system consists of edible material.

12. A method of manufacturing a system for attracting animals, the process comprising the steps of:
mixing a plurality of powdered minerals, the plurality of powdered minerals comprising sodium chloride and calcium sulphate;
mixing a volume of water and the plurality of minerals together to form a slurry;
pouring the slurry into a mold, the mold being configured to provide a shape having a recessed portion;
drying the slurry while the slurry is retained in the mold, whereby the dried slurry forms a mineral block; and
removing the mineral block from the mold.

13. The method of claim 12, further comprising the steps of:
heating a wax until the wax is in a fluid form;
infusing the fluid form of the wax with an aromatic attractant;
pouring the fluid form of the wax infused with the aromatic attractant into the recessed portion of the mineral block; and
cooling the fluid form of the wax infused with the aromatic attractant to a point at which the fluid form of the wax infused with the aromatic attractant solidifies while still retained inside of the recessed portion of the mineral block.

14. The process of claim 13, wherein the aromatic attractant comprises at least one of the group consisting of:
an acorn scent;
an apple scent;
a peanut butter scent;
a berry scent;
a animal scent; and
a molasses scent.

15. The method of claim 12, wherein the plurality of powdered minerals comprises 55 percent by mass salt and 45 percent by mass calcium sulphate.

16. The system of claim 12, wherein the plurality of powdered minerals comprises between 40 and 60 percent by mass salt and between 60 and 40 percent by mass calcium sulphate.

17. The method of claim 12, wherein the volume of water comprises a volume of water greater than or equal to 10 percent of the mass of the plurality of powdered minerals.

18. A system for attracting animals manufactured by the process comprising the steps of:
mixing a plurality of powdered minerals, the plurality of powdered minerals comprising sodium chloride and calcium sulphate;
adding a volume of water to the plurality of minerals and mixing the volume of water and plurality of minerals together to form a slurry;
pouring the slurry into a mold, the mold being configured to provide a shape having a recessed portion;
drying the slurry while the slurry is retained in the mold, whereby the dried slurry forms a mineral block;
removing the mineral block from the mold;
heating a wax until the wax is in a fluid form;
infusing the fluid form of the wax with an aromatic attractant;
pouring the fluid form of the wax infused with the aromatic attractant into the recessed portion of the mineral block; and
cooling the fluid form of the wax infused with the aromatic attractant to a point at which the fluid form of the wax infused with the aromatic attractant solidifies while still retained inside of the recessed portion of the mineral block.

19. The process of claim 18, wherein the aromatic attractant comprises at least one of the group consisting of:
an acorn scent;
an apple scent;
a peanut butter scent;
a berry scent;
a animal scent; and
a molasses scent.

20. The method of claim 18, wherein the plurality of minerals comprises 55 percent by mass salt and 45 percent by mass calcium sulphate.

21. The system of claim 18, wherein the plurality of powdered minerals comprises between 40 and 60 percent by mass salt and between 60 and 40 percent by mass calcium sulphate.

22. The method of claim 16, wherein the volume of water comprises a volume of water greater than or equal to 10 percent of the mass of the plurality of powdered minerals.
